(19) United States
(12) Patent Application Publication
(10) Pub. No.: US 2020/0063033 A1
(43) Pub. Date: Feb. 27, 2020

(54) ULTRAVIOLET-CURABLE RESIN COMPOSITION FOR BLUE LIGHT BLOCKING FILM AND BLUE LIGHT BLOCKING FILM INCLUDING THE COMPOSITION

(71) Applicant: NIPPON KAYAKU KABUSHIKI KAISHA, Tokyo (JP)

(72) Inventors: Hitoshi ASAMI, Tokyo (JP); Genki ENDO, Tokyo (JP)

(21) Appl. No.: 16/669,665

(22) Filed: Oct. 31, 2019

Related U.S. Application Data
(63) Continuation of application No. PCT/JP2018/017994, filed on May 9, 2018.

(30) Foreign Application Priority Data
May 11, 2017 (JP) 2017-094595

(51) Int. Cl. C09K 19/38; G02B 5/20; C09K 19/02; C09K 19/58

(52) U.S. Cl. CPC C09K 19/3866; C09K 19/586; C09K 19/02; G02B 5/20

(57) ABSTRACT

The ultraviolet-curable resin composition for the blue light blocking film of the present disclosure includes at least one polymerizable liquid crystal compound having a polymerizable functional group and at least one (meth)acrylate having a (meth)acryloyl group in the molecule and having a molecular weight of 200 or more. The blue light blocking film of the present disclosure includes a support body and a cured film on the support body, the cured film being obtained by curing the above-mentioned ultraviolet-curable resin composition.

### CROSS REFERENCE TO RELATED APPLICATIONS

The present application is a continuation application of International Patent Application No. PCT/JP2018/017994 filed on May 9, 2018, which claims the benefit of Japanese Patent Application No. 2017-094595, filed on May 11, 2017. The contents of these applications are incorporated herein by reference in their entirety.

### BACKGROUND

### Technical Field

The present disclosure relates to an ultraviolet-curable resin composition for a blue light blocking film and a blue light blocking film using the composition, and particularly relates to an ultraviolet-curable resin composition for a blue light blocking film which can provide a function capable of suppressing yellowing of transmitted light and haze while having a sufficient function to block light with a wavelength of around 450 nm, and relates to a blue light blocking film using the composition.

### Background

It is suggested that blue light emitted from a display device, etc. may put large strains on eyes and a body. “Blue light” is blue-color light having a wavelength range of 380 to 495 nm, and has stronger energy among visible lights. Therefore, when blue light reaches a retina without being absorbed into a cornea and a crystalline lens, it can cause damage to the retina, and also result in influences on eye strain and sleep.

In recent years, a display device provided with light emitting diodes (LED) having a large amount of blue light emission tends to be used as a light source of a display device used for a personal computer, smartphone, tablet terminal, etc. Therefore, an exposure level of blue light, in particular of blue light having a wavelength of around 450 nm is higher than conventional devices, and thus there is a risk of further increase in strains on eyes and a body caused by blue light.

As a method of suppressing exposure of blue light, the method of using a blue light blocking film, etc. which is disposed on a surface of an image display device is known. However, further improvement of properties of blue light films is required. The current blue light blocking film does not have a sufficient function of blue light blocking, and in addition, has a problem such as yellowing of transmitted light.

In view of such requests, the blue light blocking film in which yellowing is suppressed by the combination of the color material and the light diffusing particles is disclosed in Japanese Patent Laid-Open No. 2015-194553.

In International Publication No. WO 2015-093093, improvement of a function of blue light blocking by using both the liquid crystal compound having a polymerizable functional group and the compound having a naphthalimide structure is disclosed.

Since a blue light blocking film is usually applied to an optical component, a blue light blocking film is required to exhibit as high transparency as possible. As an indicator representing such transparency, haze is known and lower haze value represents higher transparency. However, the haze of the blue light blocking film described in Patent Laid-Open No. 2015-194553 becomes significantly higher because of light diffusing particles contained in the blue light blocking film. Furthermore, In International Publication No. WO 2015-093093, haze are not specifically evaluated.

### SUMMARY

The present disclosure is related to providing a ultraviolet-curable resin composition for a blue light blocking film and a blue light blocking film using the composition wherein the ultraviolet-curable resin composition can provide a function capable of suppressing yellowing of transmitted light and haze while having a sufficient function to block blue light.

According to an aspect of the present disclosure, an ultraviolet-curable resin composition for a blue light blocking film includes at least one polymerizable liquid crystal compound having a polymerizable functional group and at least one (meth)acrylate having a (meth)acryloyl group in the molecule and having a molecular weight of 200 or more.

According to another aspect of the present disclosure, a blue light blocking film includes a support body and a cured film on the support body, the cured film is obtained by curing an ultraviolet-curable resin composition including at least one polymerizable liquid crystal compound having a polymerizable functional group and at least one (meth)acrylate having a (meth)acryloyl group in the molecule and having a molecular weight of 200 or more.

Further, it is preferable that the at least one polymerizable liquid crystal compound contains a polymerizable bar-shaped liquid crystal compound.

Further, it is preferable that the ultraviolet-curable resin composition further includes a chiral agent.

Further, it is preferable that a content of the (meth)acrylate is 0.1 to 10 parts by mass based on 100 parts by mass of the polymerizable liquid crystal compound.

Further, it is preferable that the ultraviolet-curable resin composition further includes a polymerization initiator.

Further, it is preferable that a rate of blocking of blue light at 450 nm is 29 to 31% in the blue light blocking film.

The present disclosure can provide an ultraviolet-curable resin composition for a blue light blocking film and a blue light blocking film using the composition wherein the composition can provide a function capable of suppressing yellowing of transmitted light and haze while having a sufficient function to block blue light.

### BRIEF DESCRIPTION OF THE DRAWINGS

FIG. 1 is a graph showing the transmittance rate of the blue light blocking film produced in Examples 1 to 5.

FIG. 2 is a graph showing the transmittance rate of the blue light blocking film produced in Comparative Examples 1 to 8.

### DETAILED DESCRIPTION

### <Ultraviolet-Curable Resin Composition for Blue Light Blocking Film>

The ultraviolet-curable resin composition for the blue light blocking film according to the present disclosure (hereinafter, also simply referred to as “ultraviolet-curable resin composition”) is used for forming a cured film included in the blue light blocking film of the present disclosure. Such an ultraviolet-curable resin composition contains at least one polymerizable liquid crystal compound having a polymerizable functional group and at least one (meth)acrylate having a (meth)acryloyl group in the molecule and having a molecular weight of 200 or more.

### (1) Polymerizable Liquid Crystal Compound Having Polymerizable Functional Group

The ultraviolet-curable resin composition preferably contains a polymerizable bar-shaped liquid crystal compound as a polymerizable liquid crystal compound having a polymerizable functional group. The ultraviolet-curable resin composition may optionally further contains a chiral agent.

### (a) Polymerizable Bar-Shaped Liquid Crystal Compound

The polymerizable bar-shaped liquid crystal compound is, for example, a polymerizable bar-shaped nematic liquid crystal compound. Examples of polymerizable bar-shaped nematic liquid crystal compounds include azomethine, azoxy, cyanobiphenyl, cyanophenyl ester, benzoic acid ester, cyclohexanecarboxylic acid phenyl ester, cyanophenyl cyclohexane, cyano-substituted phenylpyrimidine, phenyl dioxane, tolane and alkenylcyclohexyl benzonitrile. The polymerizable bar-shaped liquid crystal compound may be a low-molecular liquid crystal compound or high-molecular liquid crystal compound, or may be a mixture of a low-molecular liquid crystal compound and high-molecular liquid crystal compound. Furthermore, the polymerizable bar-shaped liquid crystal compounds can be used alone or in combination of two or more of such compounds.

The polymerizable bar-shaped liquid crystal compound can be obtained by introducing a polymerizable group into the bar-shaped liquid crystal compound. Examples of polymerizable groups include an unsaturated polymerizable group, an epoxy group and an aziridinyl group, and the polymerizable group is preferably an unsaturated polymerizable group, particularly preferably an ethylenically unsaturated polymerizable group. The polymerizable group can be introduced into molecular of the bar-shaped liquid crystal compound by various methods. The number of polymerizable groups contained in the polymerizable bar-shaped liquid crystal compound is preferably 1 to 6, more preferably 1 to 3. Examples of polymerizable bar-shaped liquid crystal compounds include compounds described in Makromol. Chem., vol. 190, pp. 2255 (1989), Advanced Materials, vol. 5, pp. 107 (1993), U.S. Pat. Nos. 4,683,327, 5,622,648, 5,770,107, International Publication No. WO. 95/22586, International Publication No. WO 95/24455, International Publication No. WO 97/00600, International Publication No. WO98/23580, International Publication No. WO 98/52905, Japanese Patent Laid-Open No. H1-272551, Japanese Patent Laid-Open No. H6-16616, Japanese Patent Laid-Open No. H7-110469, Japanese Patent Laid-Open No. H11-80081, and Japanese Patent Laid-Open No. 2001-328973. The polymerizable bar-shaped liquid crystal compound can be used alone or in combination of two or more of such compounds. By using two or more of the polymerizable bar-shaped liquid crystal compounds in combination, orientation temperature can be decreased. Furthermore, as polymerizable liquid crystal compounds, a polymerizable bar-shaped liquid crystal compound and a non-polymerizable bar-shaped compound can be used in combination. A non-polymerizable bar-shaped compound, i.e. bar-shaped liquid crystal compound not having a polymerizable group is not particularly limited, and for example, the non-polymerizable bar-shaped compound described in Y.Goto et. al., Mol. Cryst. Liq. Cryst. 1995, Vol. 260, pp. 23-28 can be used.

### (b) Chiral Agent (Polymerizable Optically Active Compound)

Since the polymerizable bar-shaped liquid crystal compound is a liquid crystal compound which exhibits a cholesteric liquid crystal phase, the ultraviolet-curable resin composition preferably further contains a chiral agent (polymerizable optically active compound) in addition to the polymerizable bar-shaped liquid crystal compound. However, when the polymerizable bar-shaped liquid crystal compound is a molecule having an asymmetric carbon atom, it can be possible to stably form a cholesteric liquid crystal phase even if a chiral agent is not added. The polymerizable optically active compound can be selected from various known polymerizable chiral agents (for example, described in Liquid crystal device handbook, chapter 3, paragraph 4-3, TN, chiral agent for STN, pp. 199, edited by Japan Society for the Promotion of Science 142nd committee, 1989). Though the chiral agent generally contains an asymmetric carbon atom, an axially asymmetric compound or a planarly asymmetric compound which does not contain an asymmetric carbon atom can be also used as a chiral agent. Examples of axially asymmetric compounds or planarly asymmetric compound include a compound selected from the group consisting of binaphthyl, helicene, paracyclophane and derivatives thereof. A polymer having a repeating unit derived from the bar-shaped liquid crystal compound and a repeating unit derived from a polymerizable optically active compound can be formed by polymerization reaction of the chiral agent and the polymerizable bar-shaped liquid crystal compound. The polymerizable group contained in the chiral agent is preferably same as the polymerizable group contained in the polymerizable bar-shaped liquid crystal compound. Therefore, the polymerizable group of the chiral agent is preferably an unsaturated polymerizable group, epoxy group or aziridinyl group, more preferably an unsaturated polymerizable group, even more preferably an ethylenically unsaturated polymerizable group. The chiral agent may be a polymerizable liquid crystal compound. For example, among the polymerizable bar-shaped liquid crystal compound mentioned above in (a), a polymerizable liquid crystal compound different form the above-mentioned polymerizable bar-shaped liquid crystal compound used for a main component of the ultraviolet-curable resin composition can be used for the chiral agent. Such a chiral agent can be used alone or in combination of two or more of the chiral agents.

The content of the chiral agent is preferably 0.1 mol to 30 mol based on 100 mol of the polymerizable bar-shaped liquid crystal compound used in combination. When the content of the chiral agent is lower, the effect on liquid crystallinity which the polymerizable bar-shaped liquid crystal compound exhibits can be more suppressed, thus the content of the chiral agent is preferably lower. Therefore, the polymerizable optically active compound used for the chiral agent is preferably a compound which has strong torsional force in order to provide twist orientation of desired spiral pitch even in a small amount. Examples of chiral agents exhibiting such strong twist force include the chiral agent described in Japanese Patent Laid-Open No. 2003-287623.

### (2) (Meth)Acrylate Having (Meth)Acryloyl Group

A (meth)acrylate having a (meth)acryloyl group in the molecule has a molecular weight of 200 or more, preferably 230 to 2500. By using a (meth)acrylate having a (meth)acryloyl group and having a molecular weight of 200 or more, yellowing of a blue light blocking film can be suppressed.

Examples of (meth)acrylate having a (meth)acryloyl group include trimethylolpropane tri(meth)acrylate, pentaerythritol tri(meth)acrylate, pentaerythritol tetra(meth)acrylate, ditrimethylolpropane tetra(meth)acrylate, dipentaerythritol penta(meth)acrylate, dipentaerythritol hexa(meth)acrylate, reaction product of pentaerythritol tri(meth)acrylate and 1,6-hexamethylene diisocyanate, reaction product of pentaerythritol tri(meth)acrylate and isophorone diisocyanate, tris(acryloxyethyl) isocyanurate, tris(methacryloxyethyl) isocyanurate, reaction product of glycerol triglycidyl ether and (meth)acrylic acid, caprolactone-modified tris(acryloxyethyl) isocyanurate, caprolactone-modified tris(methacryloxyethyl) isocyanurate, reaction product of trimethylolpropane triglycidyl ether and (meth)acrylic acid, triglycerol di(meth)acrylate, reaction product of propylene glycol diglycidyl ether and (meth)acrylic acid, polypropylene glycol di(meth)acrylate, tripropylene glycol di(meth)acrylate, polyethylene glycol di(meth)acrylate, tetraethylene glycol di(meth)acrylate, triethylene glycol di(meth)acrylate, pentaerythritol di(meth)acrylate, reaction product of 1,6-hexanediol diglycidyl ether and (meth)acrylic acid, 1,6-hexanediol di(meth)acrylate, glycerol di(meth)acrylate, reaction product of ethylene glycol diglycidyl ether and (meth)acrylic acid, reaction product of diethylene glycol diglycidyl ether and (meth)acrylic acid, bis(acryloxyethyl) hydroxyethyl isocyanurate, bis(methacryloxyethyl) hydroxyethyl isocyanurate, reaction product of bisphenol A diglycidyl ether and (meth)acrylic acid, tetrahydrofurfuryl (meth)acrylate, caprolactone-modified tetrahydrofurfuryl (meth)acrylate, 2-hydroxyethyl(meth)acrylate, 2-hydroxypropyl (meth)acrylate, polypropylene glycol (meth)acrylate, polyethylene glycol (meth)acrylate, phenoxy hydroxypropyl (meth)acrylate, (meth)acryloyl morpholine, methoxy polyethylene glycol (meth)acrylate, methoxy tetraethylene glycol (meth)acrylate, methoxy triethylene glycol (meth)acrylate, methoxy ethylene glycol (meth)acrylate, methoxyethyl (meth)acrylate, glycidyl (meth)acrylate, glycerol (meth)acrylate, ethyl carbitol (meth)acrylate, 2-ethoxyethyl (meth)acrylate, N,N-dimethylaminoethyl (meth)acrylate, 2-cyanoethyl (meth)acrylate, reaction product of butyl glycidyl ether and (meth)acrylic acid, butoxy triethylene glycol (meth)acrylate, and butanediol mono(meth)acrylate. These can be used alone or in combination of two or more.

The content of the (meth)acrylate in the ultraviolet-curable resin composition is not particularly limited, but preferably 0.1 to 10 parts by mass based on 100 parts by mass of the polymerizable liquid crystal compound having a polymerizable group, more preferably 2 to 6 parts by mass. When the content of the (meth)acrylate is within the range of 0.1 to 10 parts by mass, both haze and yellowing of the blue light blocking film can be suppressed to a lower level simultaneously.

### (3) Polymerization Initiator

The ultraviolet-curable resin composition can further contain a polymerization initiator. The polymerization initiator is preferably a photopolymerization initiator which is capable of initiating polymerization reaction by ultraviolet irradiation. Examples of such a photopolymerization initiator is not particularly limited, but include for example, 2-methyl-1-[4-(methylthio) phenyl]-2-morpholinopropane-1-one (“Irgacure 907” manufactured by Chiba Specialty Chemicals Inc.), 1-hydroxycyclohexyl phenyl ketone (“Irgacure 184” manufactured by Chiba Specialty Chemicals Inc.), 4-(2-hydroxyethoxy)-phenyl(2-hydroxy-2-propyl)ketone (“Irgacure 2959” manufactured by Chiba Specialty Chemicals Inc.), 1-(4-dodecylphenyl)-2-hydroxy-2-methylpropane-1-one (“Darocur 953” manufactured by Merck & Co., Inc.), 1-(4-isopropyl phenyl)-2-hydroxy-2-methylpropane-1-one (“Darocur 1116” manufactured by Merck & Co., Inc.), 2-hydroxy-2-methyl-1-phenylpropane-1-one (“Irgacure 1173” manufactured by Chiba Specialty Chemicals Inc.), acetophenone compounds such as diethoxyacetophenone; benzoin compounds such as benzoin, benzoin methyl ether, benzoin ethyl ether, benzoin isopropyl ether, benzoin isobutyl ether, 2,2-dimethoxy-2-phenylacetophenone (“Irgacure 651” manufactured by Chiba Specialty Chemicals Inc.); benzophenone compounds such as benzoyl benzoic acid, methyl benzoylbenzoate, 4-phenylbenzophenone, hydroxybenzophenone, 4-benzoyl-4′-methyldiphenyl sulfide, 3,3′-dimethyl-4-methoxybenzophenone (“KAYACURE MBP” manufactured by Nippon Kayaku Co., Ltd.); thioxanthone compounds such as thioxanthone, 2-chlorothioxanthone (“KAYACURE CTX” manufactured by Nippon Kayaku Co., Ltd.), 2-methyl thioxanthone, 2,4-dimethyl thioxanthone (“KAYACURE RTX” manufactured by Nippon Kayaku Co., Ltd.), isopropyl thioxanthone, 2,4-dichlorothioxanthone (“KAYACURE CTX” manufactured by Nippon Kayaku Co., Ltd.), 2,4-diethyl thioxanthone (“KAYACURE DETX” manufactured by Nippon Kayaku Co., Ltd.), and 2,4-diisopropyl thioxanthone (“KAYACURE DITX” manufactured by Nippon Kayaku Co., Ltd.). These photopolymerization initiators can be used alone or in combination of two or more.

The content of the polymerization initiator in the ultraviolet-curable resin composition is not particularly limited, but the preferable lower limit is 0.5 parts by mass based on 100 parts by mass of the polymerizable liquid crystal compound having a polymerizable functional group, the preferable upper limit is 10 parts by mass or less, more preferable lower limit is 2 parts by mass, more preferable upper limit is 8 parts by mass.

### (4) Reaction Aid

When a benzophenone compound or a thioxanthone compound is used as a photopolymerization initiator, a reaction aid is preferably used in combination for promoting photopolymerization reaction. Examples of reaction aids are not particularly limited, but include for example, amine compounds such as triethanolamine, methyl diethanolamine, triisopropanolamine, n-butylamine, N-methyl diethanolamine, diethylaminoethyl methacrylate, Michler's ketone, 4,4′-diethylaminophenone, ethyl 4-(dimethylamino)benzoate, (n-butoxy)ethyl 4-(dimethylamino)benzoate, and isoamyl 4-(dimethylamino)benzoate. These reaction aids can be used alone or in combination of two or more.

The content of the reaction aid in the ultraviolet-curable resin composition is not particularly limited, and the reaction aid is preferably used within the range in which liquid crystallinity of the polymerizable liquid crystalline compound is not affected. Specifically, the preferable lower limit is 0.5 parts by mass based on 100 parts by mass of the polymerizable liquid crystal compound having a polymerizable functional group, the preferable upper limit is 10 parts by mass or less, more preferable lower limit is 2 parts by mass, more preferable upper limit is 8 parts by mass. Furthermore, the content of the reaction aid is preferably 0.5 to 2 times as much as the content of the photopolymerization initiator based on mass.

### (5) Other Additives

The ultraviolet-curable resin composition may further contain, as needed, various additives such as levelling agent, anti-foaming agent, ultraviolet absorber, photostabilizer, anti-oxidant, polymerization inhibitor, cross-linking agent, plasticizer, inorganic microparticle, colorant, pigment, fluorescent dye filler. By using these additives, it is also possible to provide a desired function to the ultraviolet-curable resin composition.

Examples of levelling agents include fluorine-based compounds, silicone-based compounds, and acrylic compounds.

Examples of ultraviolet absorbers include benzotriazole-based compounds, benzophenone-based compounds, and triazine-based compounds. Examples of photostabilizers include hindered amine-based compounds, and benzoate-based compounds. Examples of anti-oxidants include phenol-based compounds.

Examples of polymerization inhibitors include methoquinone, methylhydroquinone, and hydroquinone. Examples of cross-linking agents include the above-mentioned polyisocyanates, and melamine compounds.

Examples of plasticizers include phthalic acid ester such as dimethyl phthalate and diethyl phthalate, trimellitic acid ester such as tris(2-ethylhexyl)trimellitate, aliphatic dibasic acid ester such as dimethyl adipate and dibutyl adipate, orthophosphoric acid ester such as tributyl phosphate and triphenyl phosphate, and acetic acid ester such as glyceryl triacetate and 2-ethylhexyl acetate.

An inorganic microparticle, colorant, pigment, fluorescent dye, filler are not particularly limited, and can be used appropriately as needed within the range in which the present disclosure is not affected.

### (6) Solvent

In the ultraviolet-curable resin composition, a solvent can be contained as a coating liquid for viscosity control and improvement of coatability. Examples of such solvents include acetic acid esters such as ethyl acetate, butyl acetate, and methyl acetate, alcohols such as methanol, ethanol, propanol, isopropanol, and benzyl alcohol, ketones such as 2-butanone, acetone, cyclopentanone, and cyclohexanone, basic solvents such as benzylamine, triethylamine, and pyridine, and non-polar solvents such as cyclohexane, benzene, toluene, xylene, anisole, hexane, and heptane. The solvent can be added to the ultraviolet-curable resin composition in any proportion, and the solvent can be added alone or two or more solvents can be formulated. The solvent is removed by drying at a drying zone such as an oven and a film coater line.

### <Blue Light Blocking Film>

The blue light blocking film of the present disclosure includes a support body and a cured film on the support body, the cured film is obtained by curing the above-mentioned ultraviolet-curable resin composition. Specifically, The blue light blocking film of the present disclosure includes a support body and a cured film on the support body, the cured film is obtained by curing an ultraviolet-curable resin composition including at least one polymerizable liquid crystal compound having a polymerizable functional group and at least one (meth)acrylate having a (meth)acryloyl group in the molecule and having a molecular weight of 200 or more. The ultraviolet-curable resin composition used for producing the cured film also has each constituent (1) to (6) mentioned above as components contained in the ultraviolet-curable resin composition for the blue light blocking film. Such a blue light blocking film can be obtained by applying the above-mentioned ultraviolet-curable resin composition to the support body and curing the composition. Thus, the blue light blocking film of the present disclosure is formed using the above mentioned ultraviolet-curable resin composition, and thus it is possible to provide the blue light blocking film which has suppressed yellowing of transmitted light and haze while having a sufficient function to block blue light, in particular a function to block blue light of around 450 nm. The higher the rate of blocking, more preferable the function of blue light blocking is. For example, the rate of blue light blocking at 450 nm is preferably 29% to 31%, more preferably 30% or more. Yellowing of transmitted light is more preferable when the b* value is lower. When the b* value is or 1.5 or less, yellowing of transmitted light is hardly perceptible. Also, lower haze value is more preferable. When the haze value is 1.5 or less, transparency is higher, and the film is advantageous for application to optical components in which transparency is important.

Examples of the support body used for producing the blue light blocking film is not particularly limited, but include for example, film based on polyester such as polyethylene terephthalate, polybutylene terephthalate, polyethylene naphthalate and poly(cyclohexane dimethyl terephthalate), polyolefin such as polyethylene, polypropylene and polyethylene-vinyl acetate copolymer, polyvinyl chloride, polyvinylidene chloride, polycarbonate, polyamide, polyimide, polyamide imide, polyether imide, polyether sulfide, polyether sulfone, polyether ketone, polyphenylene ether, polyphenylene sulfide, polyarylate, polysulfone, polyacrylate, cellulose derivatives, cycloolefin-based polymer, liquid crystal polymer.

Among these, in terms of balance between flexibility and toughness, and versatility, the support body is more preferably a film of material selected from the group consisting of polyethylene terephthalate, polybutylene terephthalate, polyethylene naphthalate, polypropylene, polyethylene-vinyl acetate copolymer, polycarbonate, polyamide, polyimide, polyamide imide, polyphenylene ether, polyphenylene sulfide, polyarylate, and polysulfone.

The thickness of the support body is not particularly limited, and can be appropriately determined in terms of availability of the support body having desired thickness, and handling during use and transport. For example, in terms of stable transport, the thickness of the support body is preferably 5 μm or more and 250 μm or less, more preferably 12 μm or more and 188 μm or less. The support body may be further provided with a pattern, easy-adhesive layer, underlayer, and may be subjected to surface treatment such as corona treatment, and release treatment.

A method of manufacturing the blue light blocking film using the above-mentioned ultraviolet-curable resin composition is not particularly limited, and can be appropriately selected from conventional known methods. Among these, it is preferable to apply a wet coating method in terms of easy application of continuous production by roll-to-roll, increase in the area of the blue light blocking film, and enhancement of producibility. Specific examples of a wet coating method include dip coating method, air knife coating method, curtain coating method, roll coating method, wire bar coating method, gravure coating method, die coating method, blade coating method, micro gravure coating method, spray coating method, spin coating method, and comma coating method.

The blue light blocking film of the present disclosure has a cured film obtained by being cured depending on specified regularity of liquid crystal of the polymerizable liquid crystal compound contained in the above-mentioned ultraviolet-curable resin composition. The thickness of the cured film is preferably 0.1 μm or more and 10 μm or less, more preferably 0.2 μm or more and 6 μm or less.

### EXAMPLES

Hereinafter, the present disclosure will be described in more detail.

### Example 1

(Preparation of Ultraviolet-Curable Resin Composition)

The ultraviolet-curable resin composition shown in Table 1 was prepared.

TABLE 1
Composition of ultraviolet-curable resin compositions (Unit: parts by mass)

| | Ex- | Ex- | Ex- | Ex- | Ex- | Compar- | Compar- | Compar- | Compar- | Compar- | Compar- | Compar- | Compar- |
|---|---|---|---|---|---|---|---|---|---|---|---|---|---|
| | am- | am- | am- | am- | am- | ative | ative | ative | ative | ative | ative | ative | ative |
| Material (type) | ple 1 | ple 12 | ple 3 | ple 4 | ple 5 | Example 1 | Example 2 | Example 3 | Example 4 | Example 5 | Example 6 | Example 7 | Example 8 |
| Bar-shaped | 29.7 | 30.6 | 30 | 30.8 | 31.4 | 31.9 | 31.4 | 29.7 | 31.9 | 31.9 | 31.7 | 31.7 | 31.7 |
| liquid crys- | | | | | | | | | | | | | |
| tal compound | | | | | | | | | | | | | |
| Chiral agent | 1.8 | 1.9 | 1.9 | 1.8 | 1.9 | 1.9 | 1.9 | 1.8 | 1.9 | 1.9 | 1.8 | 1.8 | 1.8 |
| Photopolymer- | 1.6 | 1.6 | 1.6 | 1.6 | 1.7 | 1.7 | 1.7 | 1.6 | — | — | — | — | — |
| ization | | | | | | | | | | | | | |
| initiator A-1 | | | | | | | | | | | | | |
| Photopolymer- | — | — | — | — | — | — | — | — | 1.7 | 1.7 | 1.7 | 1.7 | 1.7 |
| ization | | | | | | | | | | | | | |
| initiator A-2 | | | | | | | | | | | | | |
| Compound B-1 | 2.6 | — | — | — | — | — | — | — | — | — | — | — | — |
| Compound B-2 | — | 1.3 | 1.3 | — | — | — | — | — | — | — | — | — | — |
| Compound B-3 | — | — | — | 1.3 | — | — | — | — | — | — | — | — | — |
| Compound B-4 | — | — | — | — | 0.7 | — | — | — | — | — | — | — | — |
| Compound B-5 | — | — | — | — | — | — | — | 2.6 | — | — | — | — | — |
| Additive C-1 | 0.1 | 0.1 | 0.1 | 0.1 | 0.1 | 0.1 | 0.1 | 0.1 | 0.1 | 0.1 | 0.1 | 0.1 | 0.1 |
| Additive C-2 | — | — | 0.7 | — | — | — | 0.7 | — | — | — | 0.7 | — | — |
| Additive C-3 | — | — | — | — | — | — | — | — | — | — | — | 0.7 | — |
| Additive C-4 | — | — | — | — | — | — | — | — | — | — | — | — | 0.7 |
| Solvent D-1 | 38.6 | 38.6 | 38.6 | 36.8 | 38.6 | 38.6 | 38.6 | 38.6 | — | — | — | — | — |
| Solvent D-2 | 25.8 | 25.9 | 25.8 | 25.8 | 25.6 | 25.8 | 25.6 | 25.8 | 33 | 33 | 33 | 33 | 33 |
| Solvent D-3 | — | — | — | — | — | — | — | — | 31.4 | 31.4 | 30.9 | 30.9 | 31.4 |

Details of the each component shown in Table 1 are as follows.
Bar-shaped liquid crystal compound: LC-242 (manufactured by BASF Corp.)
Chiral agent: LC-756 (manufactured by BASF Corp.)

### <Polymerization Initiator>

Photopolymerization initiator A-1: Irgacure 2959 (manufactured by BASF Corp.)
Photopolymerization initiator A-2: Irgacure 184 (manufactured by BASF Corp.)

### <(Meth)Acrylate Having (Meth)Acryloyl Group>

Compound B-1: “BLEMMER LA” (manufactured by NOF Corporation) Lauryl acrylate (Mw.240.4)
Compound B-2: “DPHA” (manufactured by Nippon Kayaku Co., Ltd.) dipentaerythritol hexaacrylate (Mw.578)
Compound B-3: “UX-5000” (manufactured by Nippon Kayaku Co., Ltd.) Ester-based urethane acrylate (Mw.1,500)
Compound B-4: “DPHA-40H” (manufactured by Nippon Kayaku Co., Ltd.) Urethane acrylate (Mw.2,000)
Compound B-5: “ACMO” (manufactured by KJ Chemicals Corporation) 4-Acryloyl morpholine (Mw.141)

### <Other Additives>

Additive C-1: “BYK-361N” (manufactured by BYK-Chemie GmbH) Levelling agent
Additive C-2: “Lumogen F Violet 570” (manufactured by BASF Corp.) Naphthalimide-based fluorescent dye
Additive C-3: “TINUBIN 384-2” (manufactured by BASF Corp.) Ultraviolet absorber
Additive C-4: “TINUBIN 477” (manufactured by BASF Corp.) Ultraviolet absorber

### <Solvent>

Solvent D-1: Anisole
Solvent D-2: Methyl ethyl ketone (MEK)
Solvent D-3: Cyclohexanon

### (Production of Blue Light Blocking Film)

(1) The obtained ultraviolet-curable resin composition is coated to polyethylene terephthalate film (manufactured by Toray industries, Inc. “U40”, Thickness 100 μm) using a bar coater. As for coating thickness, the clearance setting (film thickness setting) in which the rate of blue light blocking 2 shown below of 29 to 31% is obtained was used.
(2) The obtained coating film is heated at 80° C. for 1 minute to remove solvent, then the film was irradiated with a high pressure mercury lamp (manufactured by Harrison Toshiba Lighting Corporation, “HX4000L”) under the condition of 120 W/cm, line speed of 5 m/min, and one pass to cure the coating film.
(3) Thus, the blue light blocking film was produced which has the cured film formed on a polyethylene terephthalate film as a support body by using the ultraviolet-curable resin composition shown in Table 1. The film thickness of the cured film included in the blue light blocking film was about 1 μm.

### Examples 2 to 5

### (Preparation of Ultraviolet-Curable Resin Composition)

The ultraviolet-curable resin compositions shown in Table 1 were prepared.

### (Production of Blue Light Blocking Film)

The blue light blocking films were produced using the obtained ultraviolet-curable resin compositions in a similar way to Example 1. The film thickness of the cured films included in the blue light blocking films were about 1 μm in Examples 2 to 5 respectively.

### Comparative Examples 1 to 4

### (Preparation of Ultraviolet-Curable Resin Composition)

The ultraviolet-curable resin compositions shown in Table 1 were prepared.

### (Production of Blue Light Blocking Film)

The blue light blocking films were produced using the obtained ultraviolet-curable resin compositions in a similar way to Example 1. The film thickness of the cured films included in the blue light blocking films were about 1 μm in Comparative Examples 1 to 4 respectively.

### Comparative Examples 5 to 8

### (Preparation of Ultraviolet-Curable Resin Composition)

The ultraviolet-curable resin compositions shown in Table 1 were prepared.

### (Production of Blue Light Blocking Film)

The blue light blocking films were produced using the obtained ultraviolet-curable resin compositions in a similar way to Example 1, except that as for coating thickness, clearance setting (film thickness setting) in which the rate of blue light blocking 1 shown below of 25% or more is obtained was used instead of the clearance setting in which the rate of blue light blocking 2 shown below of 29 to 31% is obtained. In order to reproducing the example described in International Publication No. WO 2015-093093, the rate of blue light blocking 1 was set at 25% or more. The film thickness of the cured films included in the blue light blocking films were about 2.2 μm, 2.1 μm, 2.4 μm, 2.4 μm in Comparative Examples 5 to 8 respectively.

### Evaluation

Evaluations below were made using the blue light blocking films obtained in Examples 1 to 5 and Comparative Examples 1 to 8. The results are shown in Table 2.

### <Rate of Blue Light Blocking (BL Blocking Rate)>

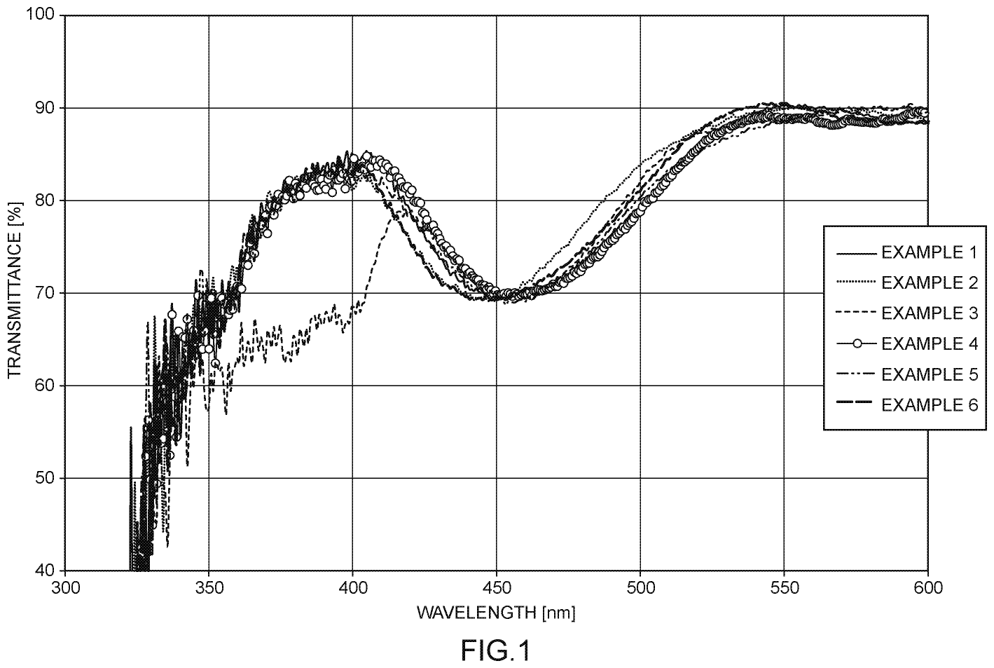

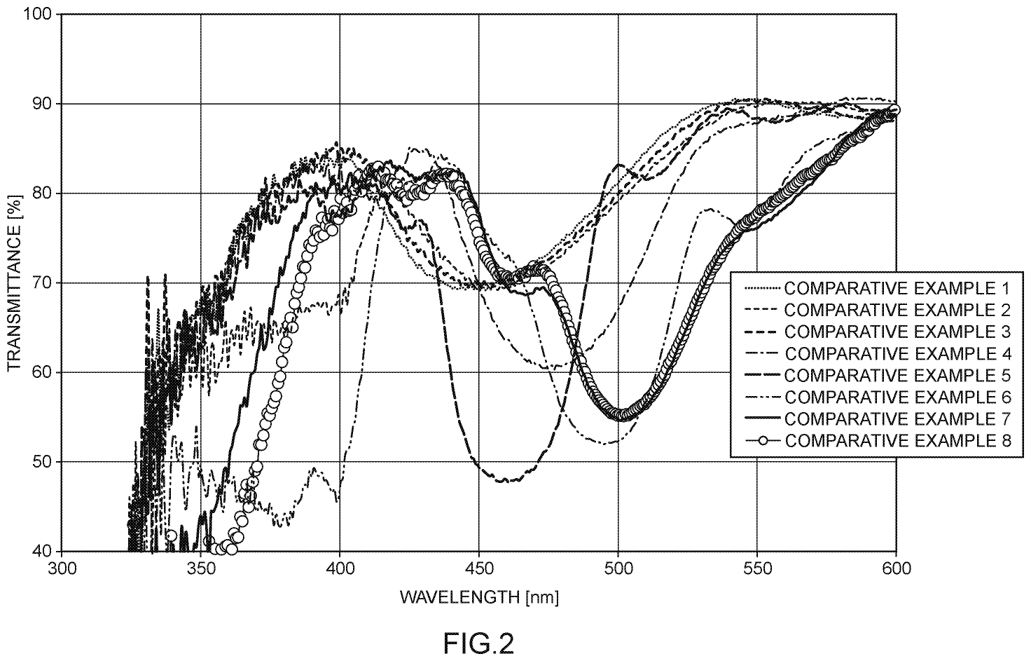

Average transmittance (%) in a region of 300 to 600 nm were measured for the blue light blocking film obtained in Examples 1 to 5 and Comparative Examples 1 to 8 using a spectrophotometer (“F20-UVX” manufactured by Filmetrics Inc.). Results are shown in FIG. 1 and FIG. 2.

### (Rate of Blue Light Blocking 1)

By applying the measurement result of the average transmittance (%) in a region of 380 nm to 495 nm to formula (1) below, average rate of blue light blocking (BL blocking rate 1) of the blue light blocking film was calculated.

BL blocking rate 1(%)=100−(average transmittance) (1)

### (Rate of Blue Light Blocking 2)

By applying the measurement result of the transmittance (%) at 450 nm to formula (2) below, rate of blue light blocking (BL blocking rate 2) of the blue light blocking film was calculated.

BL blocking rate 2(%)=100−(transmittance) (2)

### <Yellowing of Transmitted Light>

Color difference (L*a*b* color system) was measured using a color difference meter (“CM2600d” manufactured by KONICA MINOLTA, INC.) according to JIS Z8730:2009, and b* value was confirmed. Lower b* value indicates that yellowing is suppressed.

### <Haze>

Haze was measured using a Haze meter (manufactured by Tokyo Denshoku Co., Ltd.) according to JIS K7136. Lower haze value indicates higher transparency.

TABLE 2
Evaluation results of blue light blocking film

| | BL blocking | BL blocking | | |
|---|---|---|---|---|
| | rate 1 | rate 2 | | |
| | 380-495 nm | 450 nm | Yellowing | |
| | (%) | (%) | b* value | Haze |
| Example 1 | 23.9 | 30.7 | 1.25 | 1.2 |
| Example 2 | 23.9 | 29.5 | 1.38 | 1 |
| Example 3 | 27.6 | 30.3 | 0.78 | 1.1 |
| Example 4 | 23.7 | 30.2 | 0.65 | 1.3 |
| Example 5 | 24.1 | 30.4 | 1.02 | 1.2 |
| Comparative Example 1 | 24.3 | 30.3 | 2.27 | 1.1 |
| Comparative Example 2 | 27.7 | 30.1 | 2.18 | 1.1 |
| Comparative Example 3 | 23.8 | 30.1 | 5.13 | 1 |
| Comparative Example 4 | 26.2 | 30.7 | 3.28 | 1.2 |
| Comparative Example 5 | 33.3 | 50.8 | 0.88 | 1.7 |
| Comparative Example 6 | 34.4 | 23.1 | 1.62 | 2.5 |
| Comparative Example 7 | 24.7 | 22.5 | 3.33 | 3.1 |
| Comparative Example 8 | 26 | 25.4 | 3.74 | 2.9 |

As indicated in Table 2 and FIG. 1, the blue light blocking films of Examples 1 to 5 had low transmittance rate in a wavelength region of around 450 nm, and were shown to have a function to block blue light in particular around 450 nm.

Furthermore, as indicated in Table 2, the blue light blocking films of Examples 1 to 5 using the ultraviolet-curable resin composition containing a polymerizable liquid crystal compound having a polymerizable functional group and a (meth)acrylate having a (meth)acryloyl group in the molecule and having a molecular weight of 200 or more showed low haze and low b* value both of which were 1.5 or less.

On the other hand, the blue light blocking films of Comparative Examples 1 and 2 using the ultraviolet-curable resin composition not containing a (meth)acrylate having a (meth)acryloyl group had high b* value and could not suppress yellowing.

The blue light blocking film of Comparative Example 3 using the ultraviolet-curable resin composition containing a (meth)acrylate having a (meth)acryloyl group but having a molecular weight of less than 200 had significantly high b* value and could not suppress yellowing.

Blue light blocking film of Comparative Examples 5 to 8 (corresponding to Examples 1, 4, 6 and 7 respectively of International Publication No. WO 2015-093093) which was tested as confirmation of the disclosure described in International Publication No. WO 2015-093093 had high haze and inferior transparency. When the composition having the same composition as Examples of International Publication No. WO 2015-093093 was coated under the film thickness setting based on the same rate of blue light blocking 1 as Examples of International Publication No. WO 2015-093093, the obtained cured film was too thick, and thus not preferable for the appearance performance of the film applied to optical components due to roughness of the surface of the film, and furthermore, curing degree for the cured film was not sufficient.

In Comparative Example 4 in which clearance setting (film thickness setting) was adjusted so that the similar BL blocking rate to Examples 1 to 5 is obtained for the disclosure described in Example 1 of International Publication No. WO 2015-093093, haze was suppressed to a lower level, but b* value was very high and yellowing could not be suppressed. In addition, curing degree for the cured film was not sufficient. Furthermore, as indicated in FIG. 2, the blue light blocking film in Comparative Examples 5 to 8 had low performance of blocking blue light having a wavelength around 450 nm.

From the above, it was shown that the blue light blocking film obtained in Examples 1 to 5 could suppress yellowing of transmitted light and haze while having a sufficient function to block blue light, in particular blue light with a wavelength of around 450 nm. Therefore, it is found that the blue light blocking film of the present disclosure has high transparency and is advantageous for application to optical components such as eyewears and displays.

What is claimed is:

1. An ultraviolet-curable resin composition for a blue light blocking film, comprising at least one polymerizable liquid crystal compound having a polymerizable functional group and at least one (meth)acrylate having a (meth)acryloyl group in the molecule and having a molecular weight of 200 or more.

2. The ultraviolet-curable resin composition according to claim 1, wherein the at least one polymerizable liquid crystal compound contains a polymerizable bar-shaped liquid crystal compound.

3. The ultraviolet-curable resin composition according to claim 2, further comprising a chiral agent.

4. The ultraviolet-curable resin composition according to claim 1, wherein a content of the (meth)acrylate is 0.1 to 10 parts by mass based on 100 parts by mass of the polymerizable liquid crystal compound.

5. The ultraviolet-curable resin composition according to claim 1, further comprising a polymerization initiator.

6. A blue light blocking film, comprising:
a support body; and
a cured film on the support body, the cured film being obtained by curing an ultraviolet-curable resin composition comprising at least one polymerizable liquid crystal compound having a polymerizable functional group and at least one (meth)acrylate having a (meth)acryloyl group in the molecule and having a molecular weight of 200 or more.

7. The blue light blocking film according to claim 6, wherein a rate of blocking of blue light at 450 nm is 29 to 31%.

8. The blue light blocking film according to claim 6, wherein the at least one polymerizable liquid crystal compound contains a polymerizable bar-shaped liquid crystal compound.

9. The blue light blocking film according to claim 6, wherein the ultraviolet-curable resin composition further comprises a chiral agent.

10. The blue light blocking film according to claim 6, wherein a content of the (meth)acrylate is 0.1 to 10 parts by mass based on 100 parts by mass of the polymerizable liquid crystal compound.
